(19) United States
(12) Patent Application Publication
(10) Pub. No.: US 2004/0173004 A1
(43) Pub. Date: Sep. 9, 2004

(54) Robust palladium based hydrogen sensor

(76) Inventors: John P. Eblen JR., Newbury Park, CA (US); Albert D. Tomassian, West Hills, CA (US); Jeffrey H. Hunt, Chatsworth, CA (US)

Correspondence Address: Steven W. Hays, Suite 250, 28333 Telegraph Road, Southfield, MI, 48034, US

(21) Appl. No.: 10/382,187

(22) Filed: Mar. 5, 2003

(51) Int. Cl. G01N 9/00

(52) U.S. Cl. 73/31.05

(57) ABSTRACT

A hydrogen sensor having a palladium film layer used for the detection of hydrogen, e.g., in an environment susceptible to the incursion or generation of hydrogen. The palladium film layer is coated with a thin zeolite membrane that minimizes palladium surface poisoning that can occur due to the presence of atmospheric contaminants such as water vapor, ammonia, methane, carbon monoxide, and/or carbon disulphide. This improves the performance and reliability of the sensor to pinpoint hydrogen leak locations.

### TECHNICAL FIELD

The present invention generally relates to hydrogen sensors and more specifically to a robust palladium based hydrogen sensor.

### BACKGROUND ART

Sensing of gaseous hydrogen is a critical safety-related technology for hydrogen-fueled launch vehicles as well as the emerging hydrogen fuel-cell infrastructure. It is also critical to sense hydrogen in hydrogen generation and storage facilities. In the case of launch vehicles, the cryogenic storage and subsequent transport of liquid hydrogen have the potential for hydrogen leaks at sealed connections. It is critical to detect and correct hydrogen leaks prior to the accumulation of flammable or explosive concentration limits (about 4% in dry air).

Hydrogen sensors that have been used to detect hydrogen leaks on launch vehicles typically fall into two categories. One class of hydrogen sensors utilized is mass spectrometers. However, for large launch vehicles such as the Delta-IV rocket, the response time of mass spectrometers is unacceptably slow (on the order of two minutes). Also, the plumbing and physical infrastructure within these large launch vehicles severely limits the number of locations for these sensors.

Another class of hydrogen sensors is palladium-based (Pd) sensors. These sensors operate either based on reversible changes in the physical properties of palladium in the presence of gaseous hydrogen or by the use of palladium as a catalyst for reversible chemical reactions. In the field of gas sensing and analysis, it is well known that when Pd metal is exposed to hydrogen gas, hydrogen molecules dissociate on the Pd surface and the resulting hydrogen atoms can diffuse into the bulk of the Pd, eventually reaching an equilibrium concentration in the metal. It is therefore possible to measure the gaseous concentration of hydrogen by measuring one or more of the physical properties of Pd that are influenced by dissolved hydrogen. Typically, this measured parameter is a change in the electrical resistance of the palladium or palladium alloy when exposed to hydrogen gas. Thin films of palladium and palladium alloys have been used for hydrogen detection. Examples of such palladium alloys are palladium nickel and palladium silver alloys.

One type of palladium-based hydrogen sensor is a fiber-optic type hydrogen sensor. The fiber-optic sensor consists of coatings at the end of an optical fiber that sense the presence of hydrogen in air. When the coating reacts with the hydrogen, its optical properties are changed. Light from a central electric-optic control unit is projected down the optical fiber where it is either reflected from the sensor coating back to the central optical detector, or is transmitted to another fiber leading to the central optical detector. A change in the reflected or transmitted intensity indicates the presence of hydrogen. These fiber-optic hydrogen sensors can be made in a variety of configurations, with a common link being that all of the fiber-optic hydrogen sensors concepts utilize a thin film of palladium as a catalyst (mirror) on the end of the fiber optic cable.

Another type of palladium-based hydrogen sensor is an optical hydrogen sensor that utilizes fiber optic Bragg gratings (FBG) to measure the presence of hydrogen. In these sensors, a palladium sleeve is bonded to an optical fiber with a Bragg grating inside. When the palladium absorbs hydrogen, the sleeve changes in size. This size differential strains the Bragg grating (i.e. change its physical dimensions), which causes the amount of light reflected within the Bragg grating to change. This change is detected and categorized within a coupled microprocessor to indicate the presence or absence of hydrogen.

The lifetime of palladium-based sensors is limited by “poisoning” due to atmospheric contaminants, particularly water vapor, ammonia, methane, carbon monoxide, and/or carbon disulphide. It is thus highly desirable to increase the lifetime of palladium-based sensors without significantly increasing costs and without decreasing performance and reliability.

### SUMMARY OF THE INVENTION

The present invention addresses these concerns by providing a physical barrier coupled to the surface of the palladium layer of a hydrogen sensor that effectively prevents gas contaminants from reaching the palladium surface of the sensor to “poison” the palladium surface of the sensor. The present invention accomplishes this effect without introducing unacceptable lag times in the hydrogen sensing capabilities of the palladium sensor.

To accomplish this, the present invention introduces a thin film of a crystalline, inorganic, molecular sieve (zeolite) membrane onto the surface of a palladium portion of the hydrogen sensor. The sieve membrane is sized to separate hydrogen from contaminant species based on size exclusion. That is to say, these films are sized to provide minimal resistance to hydrogen flow, yet effectively block contaminants that would otherwise poison the palladium based sensors.

Palladium based sensors having the thin zeolite membrane minimizes palladium surface poisoning that occurs due to the presence of atmospheric contaminants such as water vapor, ammonia, methane, carbon monoxide, and/or carbon disulphide. This improves the performance and reliability of the sensor to pinpoint hydrogen leak locations. This in turn allows for faster repair cycles.

### BRIEF DESCRIPTION OF THE DRAWINGS

FIG. 1 is a schematic representation of a palladium based fiberoptic Bragg grating type hydrogen sensor having a zeolite film barrier according to one preferred embodiment of the present invention;

FIG. 2 is a table showing kinetic molecule diameters for gases and illustrating the two preferred zeolite membrane components of a portion of FIG. 1; and

FIG. 3 is a plan view of a palladium based hydrogen-sensing element having a Wheatstone bridge circuit utilizing the zeolite film according to another preferred embodiment of the present invention.

### BEST MODES FOR CARRYING OUT THE INVENTION

The present invention describes a hydrogen sensor that may be contained in a wide variety of applications requiring the sensing of gaseous hydrogen. Sensing of gaseous hydrogen is a critical safety-related technology for hydrogen-fueled launch vehicles as well as the emerging hydrogen fuel-cell infrastructure. It is also critical to sense hydrogen in hydrogen generation and storage facilities.

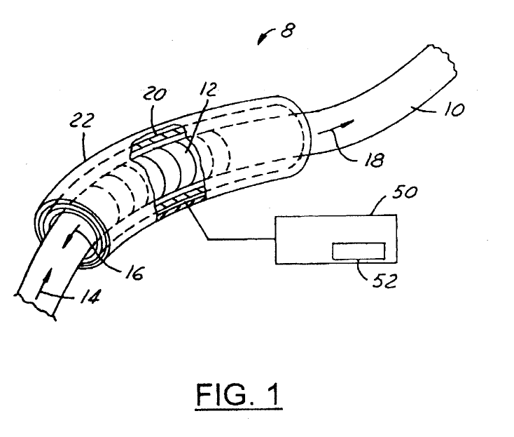

Referring now to FIG. 1, a fiber-optic type hydrogen sensor 8 according to one preferred embodiment has a known optical waveguide, or optical fiber 10, having a Bragg grating 12 impressed (or imbedded or imprinted) thereon. The fiber 10 may be made of any materials well known to those of ordinary skill in the art that allow light 14 to propagate along the fiber 10. For example, the fiber 10 may comprise a standard telecommunication single mode optical fiber.

The Bragg grating 12 generally describes any wavelength tunable grating or reflective element embedded, etched, imprinted, or otherwise formed in the fiber 10 may be used if desired. As used herein, the term “grating” means any of such reflective elements. Further, the reflective element (or grating) 12 may be used in the reflection and/or transmission of light.

The light incident on the grating 12 which reflects a portion thereof as indicated by line 16 having a predetermined wavelength band of light at a reflection wavelength lambda b, and passes the remaining wavelengths of incident light 14 (within a predetermined wavelength range), as indicated by line 18. The light readings along lines 16, 18 are read and interpreted by a coupled controller unit 50 having a microprocessor 52.

The fiber 10 with the grating 12 is encased within and fused to a palladium sleeve 20. The palladium sleeve 20 absorbs gaseous hydrogen and expands due to the presence of absorbed gaseous hydrogen. The expansion of the palladium sleeve is converted to axial strain at the core of the fiber 10 and within the grating 12. This causes the Bragg grating 12 to change its physical characteristics in response to this strain, which affects light readings 16 and 18. A coupled controller 50 reads and interprets, typically via a coupled microprocessor 52, these changed light readings 16 and 18, thereby determining the amount of gaseous hydrogen detected. When the amount of gaseous hydrogen detected reaches or exceeds a predetermined level, the controller 50 can be adapted to alert an operator.

To reduce the risk of impurity contamination (“poisoning”) of the palladium sleeve 20, and incorrect readings determined by the controller 50, a hydrogen-impermeable film 22 is coupled to the surface of the palladium sleeve 20 in areas not contacted by the fiber 10. The zeolite film 22 is a thin layer of a crystalline, inorganic, molecular sieve material having pores sized large enough to allow the minimal resistance (i.e. allow permeation) to the flow of hydrogen gas (H₂) to the palladium sleeve 20 surface but substantially prevents (i.e. are impermeable) the flow other gases to the palladium sleeve 20 surface. These gases include but are not limited to water vapor (H₂O), ammonia (NH₃), methane (CH₄), carbon monoxide (CO), and/or carbon disulphide. The film 22 is preferably applied at a thickness of about 20 microns.

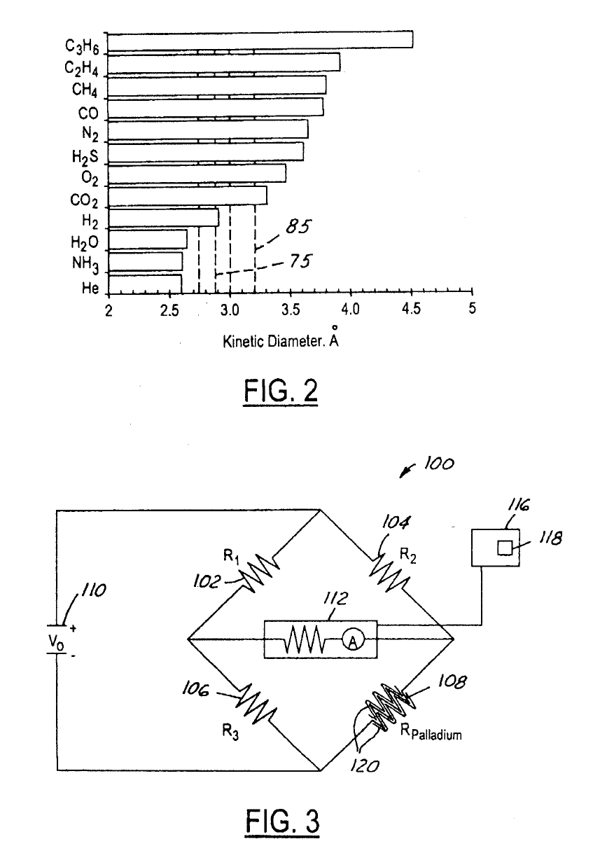

The passivating film 22 is actually formed as a combination of two separate crystal materials designed to have a bracketing porosity. As shown in FIG. 2, this is necessary because the molecule kinetic diameter of hydrogen gas, which is about 2.9 angstroms, is larger than some contaminants (such as water) but smaller than other contaminants (such as carbon dioxide and carbon monoxide).

The first crystal material, Na₃Zn₄O(PO₄)₃, shown on FIG. 2 by reference numeral 75, has a crystal structure that is impermeable to molecules having a molecular kinetic diameter of greater than about 3.0-3.2 angstroms. The second crystal material, CsZn₂OPO₄, shown on FIG. 2 by reference numeral 85, has a crystal structure that is impermeable to molecules having a molecular kinetic diameter of less than about 2.75-2.85 angstroms. Taken together, the zeolite film 22 of the present invention effectively allows molecules having a molecular kinetic diameter between about 2.85 and 3.0 angstroms to pass (i.e. has a bracketing porosity between about 2.85 and 3.0 angstroms). As shown on FIG. 2, hydrogen gas is thus the only possible contaminant listed on the chart that can pass through the pores of the zeolite film 22 to the palladium sleeve 20 surface of FIG. 1.

The zeolite film 22 shown above in FIGS. 1 and 2 may be incorporated into other hydrogen sensing elements as one of ordinary skill would realize. For example, as shown in FIG. 3, the zeolite film could be used in a hydrogen-sensing element that measures the presence of hydrogen gas electronically through changes in resistance to a Wheatstone bridge circuit.

Referring now to FIG. 3, a practical palladium based hydrogen sensor element 100 incorporates all four resistor legs of a Wheatstone resistance bridge to determine hydrogen gas concentration. The sensor element 100 consists of a common source of electrical current (such as a battery 110) and a galvanometer 112 that connects two parallel branches, containing four resistors 102, 104, 106, 108. In this preferred embodiment, the three resistors 102, 104, and 106, have known resistances R₁, R₂, and R₃ and the fourth resistor 108 is a palladium resistor 108 coated with a thin zeolite film 120 and having a resistance R_{Palladium}.

The configurations of the resistors 102, 104, 106, 108 is set up in such a way such that the electrical current through the galvanometer 112 is zero in a non-hydrogen environment. This is known as a balanced bridge. Upon exposure to hydrogen, the resistance R_{P} of the palladium resistor 108 will change, resulting in a change of voltage as measured by the galvanometer 112. A controller 116 having an associated microprocessor 118 and memory is electrically coupled with the galvanometer 112 and can receive an electrical signal indicating the change in voltage as measured by the galvanometer 112 at a given voltage input to determine the resistance R_{palladium} of the palladium resistor 108, and hence the concentration of hydrogen absorbed by the palladium resistor 108. Of course, the controller 116 may be contained within the galvanometer 112.

The controller 116 can then alert an operator when the concentration of hydrogen absorbed on the palladium resistor 108, and hence the concentration of hydrogen in the air directly exposed to the palladium resistor 108, exceeds a predetermined threshold concentration.

Of course, in alternative embodiments, the controller 116 may also determine the hydrogen concentration after the Wheatstone bridge is rebalanced. In this scenario, the resistances R₁, R₂, and R₃ of the resistors 102, 104, 106 are changed by the controller 116 at the given hydrogen concentration to balance the bridge (i.e. return the galvanometer 112 to indicate a zero voltage). The new resistance R₁, R₂, and R₃ of the resistors 102, 104, 106 are then used by the controller 116 to calculate the resistance R_{P} of the palladium resistor 108, and hence the concentration of hydrogen absorbed by the palladium resistor 108. The controller 116 can then alert an operator when the concentration of hydrogen absorbed on the palladium resistor 108, and hence the concentration of hydrogen in the air directly exposed to the palladium resistor 108, exceeds a predetermined threshold concentration.

The zeolite film 120, as described in FIG. 1, is similar in composition and thickness to the zeolite film 22 to ensure that only hydrogen gas reaches the surface of the palladium resistor 108.

Palladium based hydrogen sensors having the thin zeolite membrane minimize palladium surface poisoning that occurs due to the presence of atmospheric contaminants such as carbon disulphide, carbon monoxide, carbon dioxide, ammonia, water, and methane. This improves the performance and reliability of the sensor to pinpoint hydrogen leak locations. This in turn allows for faster repair cycles in many critical applications.

For example, in the case of launch vehicles or other space travel applications, the cryogenic storage and subsequent transport of liquid hydrogen is associated with leaks at sealed connections. It is critical to detect and correct hydrogen leaks prior to the accumulating flammable or explosive concentration limits (about 4% in dry air). Hydrogen sensors such as those described in FIGS. 1 and 3 above can thus be strategically placed throughout the launch vehicle to provide early detection of hydrogen accumulation to minimize or otherwise prevent these dangerous concentration limits. Further, by providing pinpoint leak detection, repairs may be easily made, resulting in increased service life.

Palladium based hydrogen sensors 8, 100 having a thin zeolite film 22, 120 such as those shown above in FIGS. 1 and 3 may also be placed in strategic locations within conventional fuel cells to detect hydrogen gas leakage. For example, a hydrogen sensor can be placed in close proximity at pressurized hydrogen gas inlet locations on the anode side of conventional fuel cells used to convert hydrogen gas into usable power. By minimizing hydrogen leakage at these respective inlets, as one of ordinary skill in the art appreciates, more usable power can be achieved per unit volume of hydrogen entering the anode side of the fuel cell. Further, by providing pinpoint leak detection, repairs may be easily made, resulting in increased service life of the respective fuel cell stack at increased efficiency.

While the invention has been described in terms of preferred embodiments, it will be understood, of course, that the invention is not limited thereto since modifications may be made by those skilled in the art, particularly in light of the foregoing teachings.

That is claimed is:

1. A robust hydrogen sensor comprising:
a palladium device capable of undergoing a measurable change in the presence of hydrogen gas; and
a thin layer of zeolite film coupled to a surface of said palladium device; said zeolite film having a bracketing porosity that allows the permeation of hydrogen gas to said palladium device but prevents the permeation of other gas contaminants to the surface of said palladium device.

2. The robust hydrogen sensor of claim 1, wherein said bracketing porosity is between about 2.85 and 3.0 angstroms.

3. The robust hydrogen sensor of claim 1, wherein said thin layer of zeolite film has a thickness of approximately 20 microns.

4. The robust hydrogen sensor of claim 1, wherein said thin layer of zeolite film comprises a first crystal material that is impermeable to molecules having a molecular kinetic diameter of greater than about 3.2 angstroms and a second crystal material having a crystal structure that is impermeable to molecules having a molecular kinetic diameter of less than about 2.75 angstroms.

5. The robust hydrogen sensor of claim 4, wherein said thin layer of zeolite film comprises a first crystal material that is impermeable to molecules having a molecular kinetic diameter of greater than about 3.0 angstroms and a second crystal material having a crystal structure that is impermeable to molecules having a molecular kinetic diameter of less than about 2.85 angstroms.

6. The robust hydrogen sensor of claim 4, wherein said first crystal material comprises Na₃Zn₄O(PO₄)₃.

7. The robust hydrogen sensor of claim 4, wherein said second crystal material comprises CsZn₂OPO₄.

8. The robust hydrogen sensor of claim 4, wherein said first crystal material comprises Na₃Zn₄OPO₄)₃ and wherein said second crystal material comprises CsZn₂OPO₄.

9. The robust hydrogen sensor of claim 1, wherein said palladium device comprises a palladium sleeve coupled within a fiber-optic type hydrogen sensor.

10. The robust hydrogen sensor of claim 1, wherein said palladium device comprises a palladium resistor coupled within an electronic hydrogen sensor utilizing a balanced Wheatstone bridge circuit.

11. A method for preventing contaminant poisoning of a robust hydrogen sensor utilizing a palladium device to measure changes in hydrogen gas concentration, the method comprising:
forming a zeolite film; and
coupling a thin layer of said zeolite film to a surface of the palladium device, wherein said zeolite film has a desired thickness and wherein a desired porosity of said thin layer of said zeolite film is sized to prevent the permeation of each of the possible contaminants to said surface of the palladium device while allowing the permeation of hydrogen gas molecules to said surface of the palladium.

12. The method of claim 11, wherein forming a zeolite film comprises:
forming a first layer of a first crystal material that is impermeable to molecules having a molecular kinetic diameter of greater than about 3.2 angstroms;
forming a second layer of a second crystal material that is impermeable to molecules having a molecular kinetic diameter of less than about 2.75 angstroms; and
coupling said first layer to said second layer.

13. The method of claim 11, wherein forming a zeolite film comprises:
forming a first layer of a first crystal material that is impermeable to molecules having a molecular kinetic diameter of greater than about 3.0 angstroms;
forming a second layer of a second crystal material that is impermeable to molecules having a molecular kinetic diameter of less than about 2.85 angstroms; and
coupling said first layer to said second layer.

14. The method of claim 12, wherein said first crystal material comprises Na₃Zn₄O(PO₄)₃ and wherein said second crystal material comprises CsZn₂OPO₄.

15. The method of claim 11, wherein said desired thickness is approximately 20 microns.

16. The method of claim 11, wherein the palladium device comprises a palladium sleeve coupled within a fiber-optic type hydrogen sensor.

17. The method of claim 11, wherein the palladium device comprises a palladium resistor coupled within an electronic hydrogen sensor utilizing a balanced Wheatstone bridge circuit.
